(19) United States
(12) Patent Application Publication
(10) Pub. No.: US 2013/0277294 A1
(43) Pub. Date: Oct. 24, 2013

(54) MULTI-FILTER POINT-OF-ENTRY FILTRATION SYSTEM

(71) Applicant: AQUA IP, Auburn, WA (US)

(72) Inventors: Scott Borough, Renton, WA (US); Larry Meek, Renton, WA (US); Laren Meek, Renton, WA (US)

(73) Assignee: AQUA IP, Auburn, WA (US)

(21) Appl. No.: 13/868,756

(22) Filed: Apr. 23, 2013

Related U.S. Application Data
(60) Provisional application No. 61/636,990, filed on Apr. 23, 2012.

(51) Int. Cl. B01D 29/52

(52) U.S. Cl. CPC B01D 29/52
USPC 210/232; 210/323.1

(57) ABSTRACT

The multi-filter POE water-filtration systems, to which the current application is directed, employ multiple filter modules that operate, in parallel, to filter input, untreated water. By using parallel filtration by multiple filter modules, relatively high throughput and low pressure losses are obtained. Modules are connected into the filtration system by quick-connect and quick-disconnect features which contribute to ease of use and maintenance. A three-dimensional (“3D”) network-material-based filter medium is used within the multiple filter modules, in certain examples of the multi-flow POE water-filtration system to which the current application is directed. In one example, the multi-filter POE water-filtration system includes four filter modules that filter water in parallel. In other examples, a larger number of filtration modules may be employed and, in still other examples, two or three filtration modules, rather than four, may be employed.

### CROSS-REFERENCE TO RELATED APPLICATION

This application claims the benefit of Provisional Application No. 61/636,990, filed Apr. 23, 2012.

### TECHNICAL FIELD

The current application is directed to water-filtration systems and, in particular, to a multi-filter point-of-entry filtration system in which water is filtered, in parallel, in multiple filters.

### BACKGROUND

Point-of-entry (“POE”) filtration systems are commonly used for initial filtration of water provided by public water utilities to residential and commercial buildings. While relatively cost effective for initial filtering of potentially contaminated water, currently available POE filtration systems suffer from steadily increasing pressure losses due to filter-media compaction as well as difficult-to-monitor decreases in filter efficiency due to creation, over time, of macroscopic channels in the filter medium that facilitates rapid transport of water and decreased areas of contact and contact times of the water and filtration medium as well as catastrophic decrease in efficiency when the filter media becomes saturated with sequestered contaminants. Owners and residents of residential and commercial buildings continue to seek efficient and cost-effective POE filtration systems.

### SUMMARY

The multi-filter POE water-filtration systems, to which the current application is directed, employ multiple filter modules that operate, in parallel, to filter input, untreated water. By using parallel filtration by multiple filter modules, relatively high throughput and low pressure losses are obtained. Modules are connected into the filtration system by quick-connect and quick-disconnect features which contribute to ease of use and maintenance. A three-dimensional (“3D”) network-material-based filter medium is used within the multiple filter modules, in certain examples of the multi-flow POE water-filtration system to which the current application is directed. In one example, the multi-filter POE water-filtration system includes four filter modules that filter water in parallel. In other examples, a larger number of filtration modules may be employed and, in still other examples, two or three filtration modules, rather than four, may be employed.

### BRIEF DESCRIPTION OF THE DRAWINGS

FIG. 1 shows a quadroflow POE water-filtration system that represents an example of the multi-filter POE systems to which the current application is directed.

FIG. 2 provides an exploded diagram of one example of the multi-filter-element POE water-filtration system to which the current application is directed.

FIG. 3 provides a detailed illustration of an actual example of the quadroflow POE water-filtration system that represents an example of the multi-filter-element POE water-filtration systems to which the current application is directed.

### DETAILED DESCRIPTION

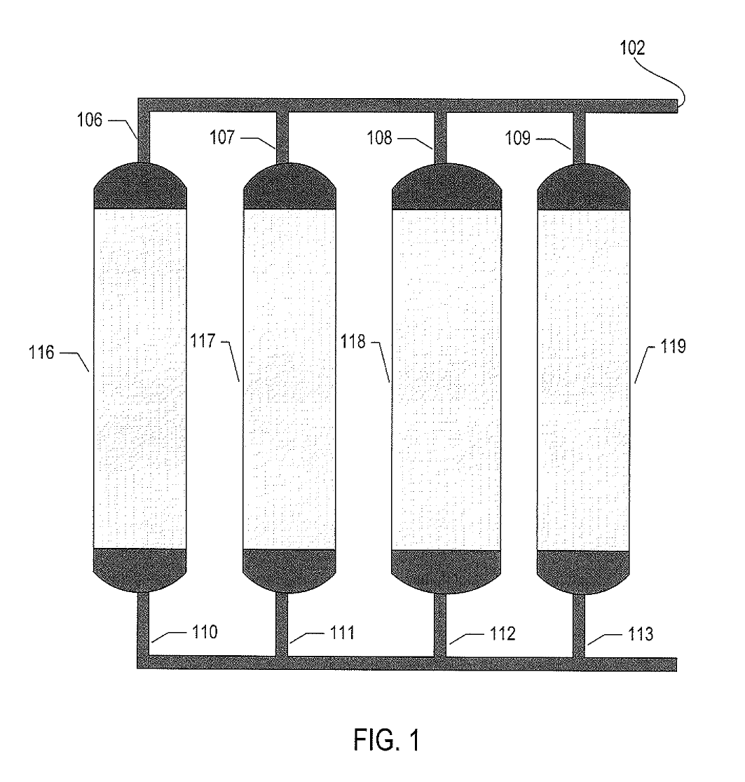

The current application is directed to multi-filter-element POE water-filtration systems. FIG. 1 shows, in schematic form, a quadroflow POE water-filtration system that represents an example of the multi-filter POE systems to which the current application is directed. The quadro flow POE filtration system may be mounted with the filter elements vertically oriented or horizontally oriented, or in any other orientation. Unfiltered, source water is input into a source pipe 102 and filtered water is output from an output pipe 104. Both the input pipe 102 and output pipe 104 branch into four separate, interconnected filter taps, the input pipe branching into four input filter taps 106-109 and the output pipe branching into four output taps 110-113. The input water thus flows, in parallel, through four different filter modules or filter elements 116-119. Each of the four filter elements, or filter housings, comprises a hollow, cylindrical plastic housing with fittings at each end to accommodate the input and output taps, respectively, within which a cylindrical three-dimensional (“3D”) network-material-based filter medium is snugly fit. The 3D-network-material-based medium generally includes activated carbon, but may also include additional and/or different materials and compounds, including copper-zinc media, metal oxides, silver, and resins. The 3D-network-material-based filter medium filtration medium is robust, does not need backwashing for periodic cleansing, and provides many more times greater surface area than a comparable amount of granular activated carbon filter medium. As water flows, in parallel, through multiple filter elements, there is minimal pressure loss across the four-filter-element POE system and lower water throughput through each filter element. The larger volume of four filters, compared to a single filter, insures that flow is not restricted, and pressure is not raised, within the filter media.

The 3D-network-material-based filter medium, when impregnated with activated carbon, effectively removes various types of organic-compound contaminants, some particulates, and other types of contaminants. The 3D-network-material-based filter medium is formed by a process that cross-links or interlaces powdered materials to increase their surface area and enhance their adsorption capacity.

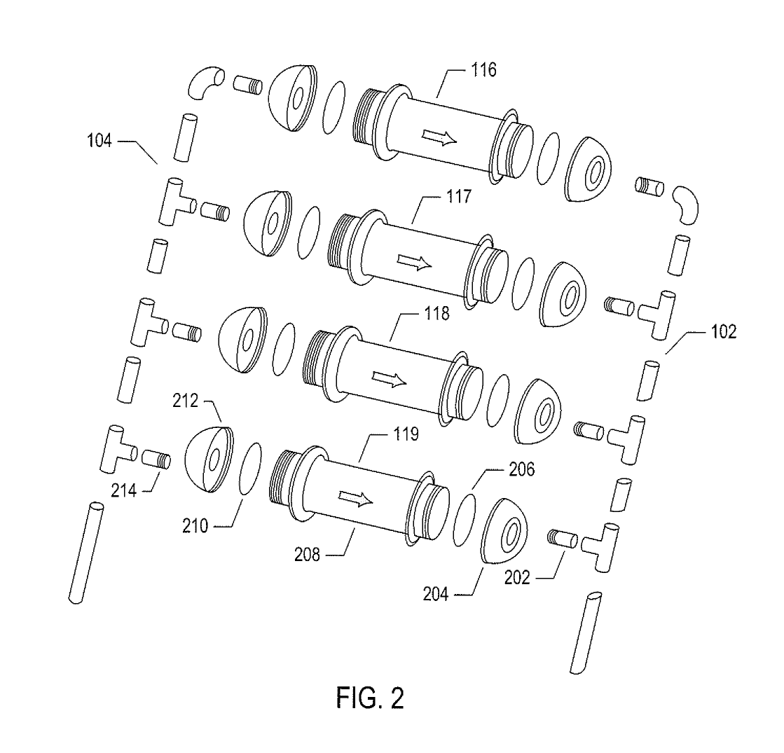

FIG. 2 provides an exploded diagram of one example of the multi-filter-element POE water-filtration system to which the current application is directed. FIG. 2 shows many of the elements shown in FIG. 1, which are provided with the same numerical labels as used in FIG. 1 for conciseness of description. Each filter element can be seen to comprise an input fitting 202, a first end cap 204, an O-ring 206, a filter-element housing 208, a second O-ring 210, a second end cap 212, and an output fitting 214.

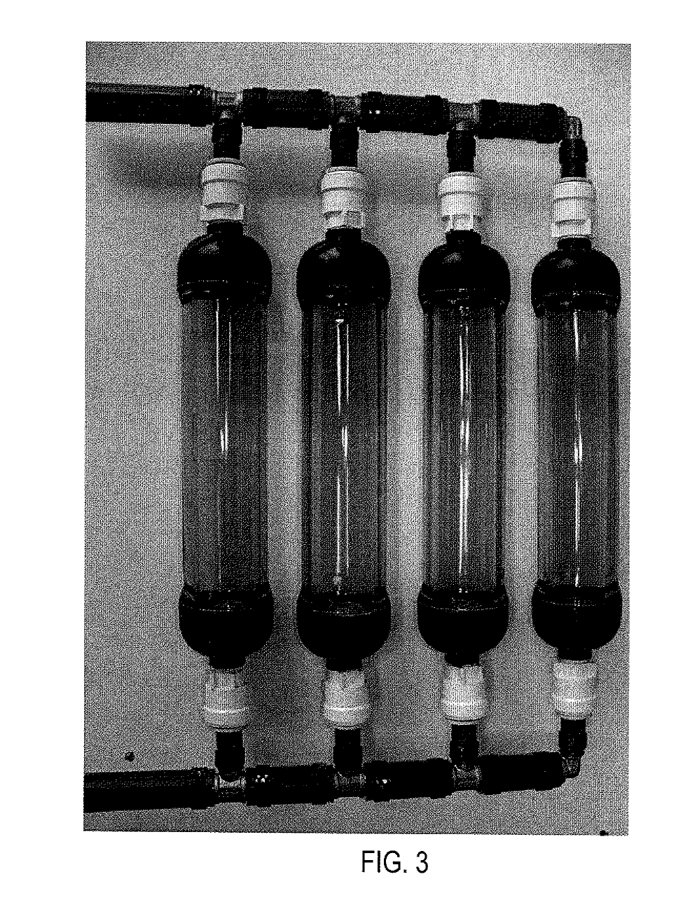

FIG. 3 provides a detailed illustration of an actual example of the quadroflow POE water-filtration system that represents an example of the multi-filter-element POE water-filtration systems to which the current application is directed.

Although the present invention has been described in terms of particular embodiments, it is not intended that the invention be limited to these embodiments. Modifications within the spirit of the invention will be apparent to those skilled in the art. For example, alternative examples of the multi-filter-element POE water-filtration system may use two or three filter elements, rather than four filter elements or, alternatively, may use more than four filter elements. These different types of filter media may be used within the filter elements, including variations of the above-mentioned 3D-network-material-based filter medium cylindrical filter media. In alternative examples, manual shutoff valves may be included to isolate particular filter elements for removal and replacement while the remaining filter elements continue to operate.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A multi-filter point-of-entry water-filtration system comprising:
an input pipe;
two or more input filter taps that branch from the input pipe that each delivers pressurized water to one of two or more filter modules;
the two or more filter modules, each comprising a water-tight housing that encloses a filtration medium;
two or more output filter taps that each delivers water from one of two or more filter modules to an output pipe that, in turn, delivers filtered water to internal water-supply lines of a building or facility.

2. The multi-filter point-of-entry water-filtration system of claim 1 wherein each input filter tap is connected to an input port of one of the two or more filter modules by a quick-connect/quick-disconnect fitting.

3. The multi-filter point-of-entry water-filtration system of claim 1 wherein each output filter tap is connected to an output port one of the two or more filter modules by a quick-connect/quick-disconnect fitting.

4. The multi-filter point-of-entry water-filtration system of claim 1 wherein each filter module comprises:
a first cap with an input port and having a threaded receptacle;
a first O-ring;
a second cap with an output port and having a threaded receptacle;
a second O-ring; and
a housing with a first threaded protuberance, on a first end, and a second threaded protuberance on a second end, the first O-ring mounted over the first threaded protuberance and the O-ring-mounted first threaded protuberance threaded into the first cap, and the second O-ring mounted over the second threaded protuberance and the O-ring-mounted second threaded protuberance threaded into the first cap.

5. The multi-filter point-of-entry water-filtration system of claim 4 wherein each of the two or more filter module encloses a cylindrical 3D-network-material-based filter medium.

6. The multi-filter point-of-entry water-filtration system of claim 5 wherein the cylindrical 3D-network-material-based filter medium is impregnated with active carbon.

7. The multi-filter point-of-entry water-filtration system of claim 6 wherein the cylindrical 3D-network-material-based filter medium is additionally impregnated with one or more of:
a resin;
a metal-dioxide substance; and
a metal.

8. The multi-filter point-of-entry water-filtration system of claim 6 wherein the multi-filter point-of-entry water-filtration system includes four filter modules.
